(19) United States
(12) Patent Application Publication
(10) Pub. No.: US 2003/0133521 A1
(43) Pub. Date: Jul. 17, 2003

(54) AUTOMATIC GAIN CONTROL MECHANISM FOR AN ANALOG-TO-DIGITAL CONVERTER

(76) Inventors: Mr. Tsung-Hui Chen, Hsinchu (TW); Mr. Chao-Ming Chang, Hsinchu (TW)

(21) Appl. No.: 10/248,360

(22) Filed: Jan. 14, 2003

Related U.S. Application Data
(60) Provisional application No. 60/349,205, filed on Jan. 15, 2002.

(51) Int. Cl. H04L 27/08

(52) U.S. Cl. 375/345

(57) ABSTRACT

### Abstract of Disclosure

An auto gain control (AGC) algorithm which is suitable for a digital processing system. The AGC algorithm includes an adaptive stage and a sleeping and tuning stage. In the adaptive stage, determining if an strength of a first received signal is within a first range and is larger than a second threshold value, if no, measuring strength for sequentially received signals by adaptively adjusting the gain of the AGC algorithm until the strength of one of the sequentially received signals is within the first range and is larger than the second threshold value. In the sleeping and tuning stage, the AGC algorithm stops tuning the gain for a first period, and then measuring strength for sequentially received signals by iteratively adjusting the gain of the AGC algorithm until the strength of the other one of the sequentially received signals is within a second range. When the strength is within the second range, setting the gain according to the energy and locking the gain for remaining sequentially received signals.

### Cross Reference to Related Applications

This application claims the priority benefits of U.S. provisional application titled "AUTOMATIC GAIN CONTROL FOR INPUT TO ANALOG-TO-DIGITAL CONVERTER" serial no. 60/349,205, filed on January 15, 2002. All disclosures of these applications are incorporated herein by reference.

### Background of Invention

Field of the Invention

The invention relates in general to a mechanism for a digital processing system. More particularly, the invention relates to a mechanism for a digital processing system using an analog-to-digital converter, having a capability of automatic gain control by an adaptive stage and a sleeping and tuning procedure.

Description of the Related Art

Automatic gain control ("AGC") is one of the essential mechanisms required to implement a digital processing communication system. The purpose of AGC is to re-scale the input signal such that the magnitude of the analog signal reaches a desired level when it is input into an analog to digital converter (ADC) in a variety of receiving power levels.{ok}

A conventional mechanism for a digital processing system using an analog-to-digital converter is shown in Fig.1. In the mechanism, an analog amplifier 110 is used for amplifying input analog signals in response to a gain control signal from an automatic gain control (AGC) unit 140. The output of the analog amplifier 110 is coupled to an analog filter 120, which is used for filtering the amplified signals . The filtered output of the analog filter 120 is coupled to an analog-to-digital converter (ADC) 130. The ADC 130 converts the filtered output of the analog filter 120 of an analog form into that of a digital form. The digital signals converted from the filtered output of the analog filter 120 by the ADC 130 are transmitted to a digital processing receiver for data processing. The digital signals are also fed to the AGC unit 140 and the gain control signal of the AGC unit 140 is generated therefrom. The digital processing AGC unit 140, due to the saturation effect of ADC, cannot tell the strength of the received signal when ADC saturates. This weakness of the digital processing AGC unit 140 increases the time required to re-scale the received signal into a desired level. This feature also suggests the implementation of the AGC unit 140 with an adaptive algorithm to scale the received signal until it reaches the desired signal level.

Mechanisms with such adaptive algorithms for automatic gain control are known in the art of the data processing system. For example, Arens et al. in US Pat. No. 5,301,364, titled "Method and Apparatus for digital automatic gain control in a receiver," discloses a mechanism for automatic gain control in a receiver. In the Arens '364 patent, the AGC gain (named AGC setting, AGC number, or GAGCN) is generated based on the so-called AGC Error (AGCE). The AGCE is obtained based on the power error. The power error is the value by subtracting the average power from a preset, desired power level. (Col. 4, Line 19-25). In the Arens '364 patent, difference in power between the desired signal and a signal received is calculated and provided for open loop gain control for the signal, scaled by the receiver's gain characteristics. However, factors of power error and desired power level should be obtained first. Furthermore, the mechanism with the adaptive algorithm does not consider the existence of a loop delay time in the control loop.

In another example, Carl G. Scarpa in U.S. Pat. No. 5,563,916, titled "Apparatus And Method For Varying The Slew Rate Of A Digital Automatic Gain Control Circuit," discloses a AGC circuit with variable step sizes. In the Scarpa '916 patent, an ABS circuit is provided for obtaining an absolute value level of the signal, which is then communicated to a lock detect circuit to determine how far out of the desired range the signal is, thereby requiring large step changes for a fast, coarse adjustment or smaller step changes fine adjustment of the gain. However, the mechanism of the digital automatic gain control circuit does not also consider the existence of a loop delay time in the control loop.

On the other hand, the loop delay in the close-loop control system of AGC, referring to Fig.1, such as the delay caused by the ADC 130, analog circuits (not shown), and the AGC unit 140 further increases the time for the AGC mechanism to reach the stable state. Delayed adaptive algorithms have been extensively studied in the art, for example, "Delayed adaptive LMS filtering: current results" by Haimi-Cohen, R.; Herzberg, H.; Be'ery, Y. 1990 International Conference on Acoustics, Speech, and Signal Processing, 1990. ICASSP-90, vol.3, 1990, pp. 1273-1276. In the literature, the time for convergence is proportional to the loop delay. However, neither of the digital processing systems with an AGC unit using an adaptive algorithm for adjusting received signals considers a loop delay occurred in the digital processing system.

### Summary of Invention

The invention provides a fast convergent automatic gain control (AGC) algorithm which is suitable for a digital processing system. The algorithm combats the difficulty of the saturation effect due to the analog to digital converter (ADC) and speeds the time to convergence.

The invention provides a fast convergent automatic gain control (AGC) algorithm which is suitable for a digital processing system. The algorithm combats the loop delay in the close-loop control system of the AGC algorithm, in order to reduce the time to reach a stable state.

In accordance with the foregoing and other objectives, the invention provides an automatic gain control (AGC) algorithm which is suitable for a digital processing system. The AGC algorithm comprising an adaptive stage and a sleeping and tuning stage. In the adaptive stage, determining strength of a first received signal is within a first range and is larger than a second threshold value. If no, strength of sequentially received signals is measured by adaptively adjusting the gain of the AGC algorithm until the strength of one of the sequentially received signals is within the first range and is larger than the second threshold value. In the sleeping and tuning stage, the AGC algorithm stops tuning the gain for a first period, and then measures strength for sequentially received signals by iteratively adjusting the gain of the AGC algorithm until the strength of the other one of the sequentially received signals is within a second range and when the energy is within the second range. Setting the gain according to the strength and locking the gain for remaining sequentially received signals.

In accordance with the foregoing and other objectives, the invention provides a method for automatically controlling a gain of a digital processing system. The digital processing system sequentially receives a plurality of analog signals. In the method, strength of one of the analog signals is calculated. Then, it is determined that the strength is within a first range and is larger than a second threshold value. If no, strengths of first following received analog signals are sequentially calculated by adaptively adjusting the gain until one of the strengths of the first following received analog signals is within the first range and than the second threshold value. Then stop tuning the gain for a first period. After the first period, strengths of second following received analog signals are sequentially calculated. It is then determined that the strength is within a second range. If no, the gain of the AGC algorithm is iteratively adjusted until one of the strengths of the second following received analog signals is within the second range. Then, the gain is set according to the strength and the gain for remaining sequentially received signals is set.

In accordance with the foregoing and other objectives, the invention provides an automatic gain control (AGC) algorithm which is suitable for a digital processing system. The digital processing system sequentially receives a plurality of analog signals. The AGC algorithm includes sequentially measuring strength for each of the sequentially received analog signals by adaptively adjusting the gain of the AGC algorithm until the strength of one of the sequentially received analog signals is within a first range and is larger than a second threshold value; and stops tuning the gain of the AGC algorithm for a first period, and then measuring strength for the sequentially received analog signals by iteratively adjusting the gain of the AGC algorithm until the strength of the other one of the sequentially received analog signals is within a second range and when the strength is within the second range, setting the gain according to the strength and locking the gain for remaining sequentially received analog signals.

In the above AGC algorithm or method for automatically controlling a gain, the adaptive stage is initialized when the strength of one of the sequentially received signals is larger than a first threshold value. In a preferred embodiment, first threshold value is smaller than the second threshold value.

In the above AGC algorithm or method for automatically controlling a gain, the gain is adaptively adjusted in accordance with the strength of the sequentially received signals. The strength can be the average envelope, or the power of the sequentially received signal.

In the above AGC algorithm or method for automatically controlling a gain, the gain is adaptively adjusted by looking up a table. The table includes step sizes for adaptively adjusting the gain. The step sizes are modified according to a loop delay occurred in the digital processing system. In an alternative embodiment, the step size of the table is inversely proportion to the value of the loop delay occurred in the digital processing system. In another alternative embodiment, the gain is adaptively adjusted by looking up the table in accordance with the strength of the sequentially received signal. The gain is adaptively adjusted in a range between a maximum value and a minimal value.

Both the foregoing general description and the following detailed description are exemplary and explanatory only and are not restrictive of the invention, as claimed.

It is to be understood that both the foregoing general description and the following detailed description are exemplary, and are intended to provide further explanation of the invention as claimed.

### Brief Description of Drawings

The accompanying drawings are included to provide a further understanding of the invention, and are incorporated in and constitute a part of this specification. The drawings illustrate embodiments of the invention and, together with the description, serve to explain the principles of the invention. In the drawings,

Figure 1 is a conventional mechanism for a digital processing system using an analog-to-digital converter;

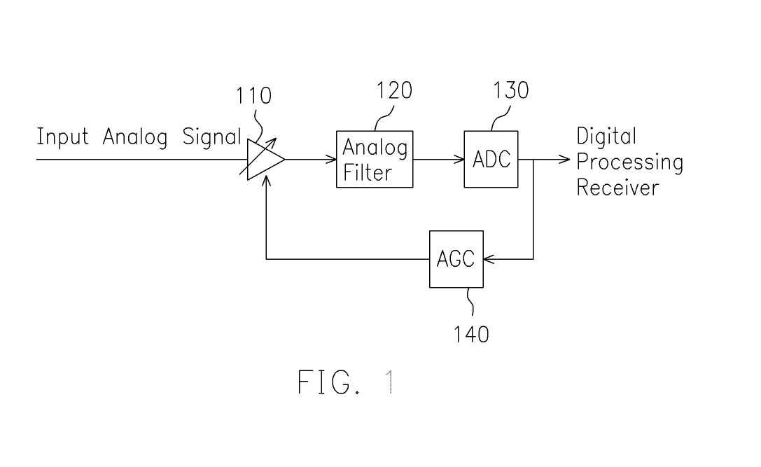

Figure 2 is a overall flow diagram of a preferred embodiment of a proposed fast convergent AGC algorithm of the invention; and

Figure 3 is a preferred embodiment of the AGC algorithm employed in a digital processing system meeting the requirements of the specifications of IEEE 802.11b.

### Detailed Description

Reference will now be made in detail to the present preferred embodiments of the invention, examples of which are illustrated in the accompanying drawings. Wherever possible, the same reference numbers are used in the drawings and the description to refer to the same or like parts.

A preferred embodiment of the present invention provides a novelty automatic gain control ("AGC") algorithm, which is suitable for a digital processing system. The AGC algorithm combines advantages of the adaptive algorithm and an one-shot estimator such that the introduced AGC avoids the saturation effect due to the analog to digital converter (ADC) and converges faster than the conventional adaptive AGC algorithms.

For overcoming the difficulties of the conventional AGC algorithm, an adaptive algorithm is introduced in the preferred embodiment for adjusting received signals. In considering the loop delay, the step size in the adaptive algorithm of the preferred embodiment is modified according to the loop delay. The loop delay means that the AGC adapts the gain, for example, at time instance t₀, however, the measured average strength of the signal would not be updated immediately, ie. at the same time instance t₀, affected by the updated gain. It needs a response time so that the measured signal strength can reflect the updated gain. Due to such a delay, the gain adaptation should be conservative. That means the step size of the gain adaptation should not be too large. A smaller step size is used for a longer loop delay. That is, larger loop delay suggests smaller step size and vice versa.

The step size is used in the adaptive algorithm for increasing or decreasing the gain set in the AGC algorithm. To ease the process for the AGC algorithm to compute the gain for tuning the incoming analog signal, a table of a preferred embodiment provided for looking up the step size is introduced in the embodiment.

In addition, to reduce the time for convergence, the AGC algorithm is split into two stages in sequence, including an adaptive stage and an sleeping and tuning stage. These two stages are explained in details in the following description.

IN THE ADAPTIVE STAGE

The proposed AGC algorithm enters the adaptive stage whenever an indicator, such as energy detector (ED), is positive. The ED is used to indicate the presence of non-thermal signals and is obtained by measuring the strength of the received signals. In an alternative embodiment, the strength of received signal is used to represent the indicator to reflect how strong the signal is. The possible indicator for the strength of a signal includes, for example, the envelope of the signal and the power of the signal. In order to ease the description below, the envelope of the signal is adopted to represent the strength of the signal. However, the power of the signal can also be applicable to represent the strength of the signal in the invention. When the envelope of the measured signal is below a first predetermined threshold TH₁, ED is set to be negative and it is believed that there is only thermal noise in the medium. On the other hand, when the envelope is larger than a second predetermined threshold TH₂, ED is set to be positive and it is believed that there are signals (including the desired signals or the possible inferences) in the medium. In order to avoid a ping-pong effect, the second predetermined threshold is preferably set to be higher than the first predetermined threshold. That is, TH₁ < TH₂.

During the adaptive stage, the AGC algorithm adapts the AGC gain according to the measured strength of the received signal. A table of strength range versus the step size is built in advance, as desired. The table has a form, for example, as following:

TABLE 1

| Range | Gain Adjustment Value (Δ dB) |
|---|---|
| 1.30˜ | −27 |
| 1.16˜1.30 | −8 |
| 1.03˜1.16 | −7 |
| 0.92˜1.03 | −6 |
| 0.82˜0.92 | −5 |
| 0.73˜0.82 | −4 |
| 0.65˜0.73 | −3 |
| 0.58˜0.65 | −2 |
| 0.52˜0.58 | −1 |
| 0.46˜0.52 | 0 |
| 0.41˜0.46 | 1 |
| 0.37˜0.41 | 2 |
| 0.33˜0.37 | 3 |
| 0.29˜0.33 | 4 |
| 0.26˜0.29 | 5 |
| 0.23˜0.26 | 6 |
| 0.21˜0.23 | 7 |
| 0.18˜0.21 | 8 |
| 0.16˜0.18 | 9 |
| 0.15˜0.16 | 10 |
| ˜0.15 | 27 |

In the adaptive stage, the AGC algorithm keeps measuring the envelope of the received signal. More specifically, the AGC algorithm keeps measuring the average envelope of the received signal over a predetermined period. Using the average envelope as an index, a corresponding step size can be obtained according to the above table. Then the AGC algorithm adapts the AGC gain based on the step size, as denoted "Δ" in the table above. That is, the gain of the AGC algorithm is updated to the gain of the AGC algorithm plus the Δ, in dB scale.

Once the average envelope of the received signal falls within a first predetermined range and, of course, ED is still positive, the AGC algorithm leaves the adaptive stage and then enters the second stage (as defined above, the "sleeping and tuning stage").

IN THE SLEEPING AND TUNING STAGE

When the AGC algorithm enters the sleeping and tuning stage, it first stops tuning the gain on the incoming analog signal for a predetermined period of time (which is in a status of a "sleeping mode") and then tunes the gain on the following incoming analog signals according to the measured envelope (which is in a status of a "tuning mode"). The predetermined period of time for the sleeping mode, in a preferred embodiment, depends on the loop delay occurred in the digital processing system. The stage is iteratively repeated until the average envelope falls within a second predetermined range, which is a sub-range of the first range. Once the measured average envelope falls within the second range, the gain of he AGC gain is locked.

The second predetermined range is known as a range between two power levels. These two power levels are much closer to the desired energy than the power levels in the first predetermined range.

THE FAST CONVERGENT AGC ALGORITHM

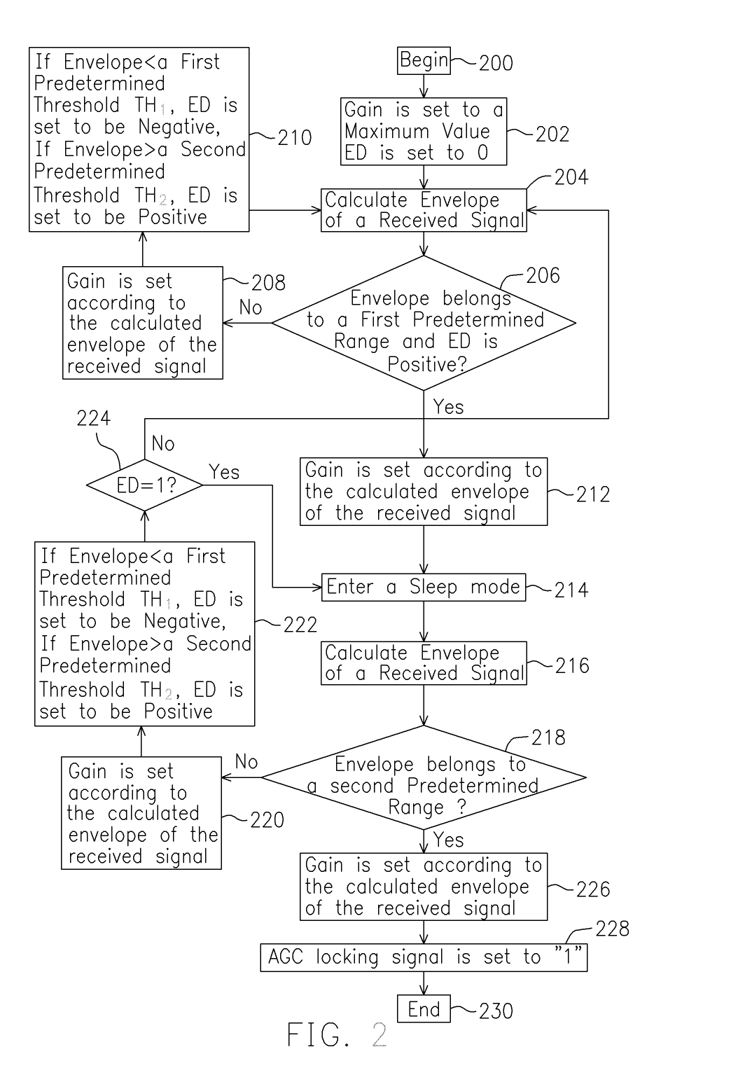

The overall flow diagram of the preferred embodiment of the proposed fast convergent AGC algorithm is shown in Fig.2. When analog signals are sequentially received, in the step 200 for the initial beginning, the gain of the AGC algorithm is set to a maximum value and ED is set to 0, in step 202. After initialization, the envelope of a first received signal is calculated, in step 204, and in step 206, if the average envelope belongs to a first predetermined range and ED is positive, enter step 212, which is described later. When the calculated envelope is below a first predetermined threshold TH₁, it is believed that there is only thermal noised in the medium and ED is set to be negative. The predetermined threshold is design as desired and as application therewith.

If the calculated envelope does not belong to the first predetermined range and ED is not positive, as in step 208, the gain of the AGC algorithm is adjusted and set according to the calculated envelope of the received signal. The gain is preferably restricted within a range which is between the above-mentioned maximum value and a minimal value, as desired. In the following step 210, ED is determined according to an average envelope of a following received signal after the gain is adjusted. If the envelope is smaller than the above-mentioned first predetermined threshold TH₁, ED is set to be negative.. If the envelope is larger than a second predetermined threshold TH₂, ED is set to be positive. In order to avoid a ping-pong effect due to noises, the second predetermined threshold TH₂ is preferably set to be lager than the first predetermined threshold TH₁. After the step 210, a following received signal is amplified in according to the newly adjusted gain and steps 204 and 206 are performed again. The envelope of the following received signal is calculated, in step 204, and is then determined, in step 206, if the envelope belongs to a first predetermined range and ED is positive. When the calculated envelope is below the first predetermined threshold TH₁, it is believed that there is only thermal noised in the medium.

If the calculated envelope belongs to the first predetermined range and ED is positive, step 212 following the step 206 is performed. In step 212, the gain of the AGC algorithm is adjusted and set according to the calculated envelope of the received signal. The gain is preferably restricted within a range which is between the above-mentioned maximum value and the minimal value. Then, the AGC algorithm enters a sleeping mode, in which the gain stops tuning for sequentially incoming analog signals for a predetermined period of time. Then, as in step 216, the envelope of following signal received during the sleeping mode is calculated and is determined, as in step 218, if the envelope of the following received signal belongs to a second predetermined range. The second predetermined range is known as a range between two power levels. These two power levels are much closer to a desired energy than the power levels in the first predetermined range.

If the calculated envelope in step 218 does not belong to the second predetermined range, the gain of the AGC algorithm is adjusted and set according to the calculated envelope of the received signal, as in step 220. The gain is preferably restricted within the range between the above-mentioned maximum value and the minimal value. In following step 222, ED is determined according to an average envelope of a following received signal after the gain is adjusted. If the envelope is smaller than the above-mentioned first predetermined threshold TH₁, ED is set to be negative. If the gain is larger than the above-mentioned second predetermined threshold TH₂, ED is set to be positive. In following step 224, if ED is not positive, the AGC algorithm goes back to step 204. If ED is positive, the AGC algorithm goes back to step 214, entering the sleep mode.

If the calculated envelope in step 218 belongs to the second predetermined range, the gain of the AGC algorithm is adjusted and set according to the calculated envelope of the received signal, as in step 226 and then locking the AGC algorithm by setting a locking signal being in a status of logic high, as in step 228. That is, the gain of the AGC algorithm in the processing system is locked.

To ease the process for the AGC algorithm for computing the gain for tuning the incoming analog signal according to the measured envelope, in a preferred embodiment, a table-lookup procedure is preferably introduced in the preferred embodiment. The table-lookup procedure is alternatively introduced in steps 208, 220 or 226, for adjusting the gain by looking up a table in according to the calculated energy of the received signal, as shown in Table 1 above. It is easy to see that the proposed AGC algorithm is convergent and time for convergence depends on the period of time in the sleeping mode. It is also apparently to realize the algorithm converges faster than the conventional algorithm in which only the adaptive algorithm is employed.

In addition, by memorizing the gain value locked in a previous packed, the proposed AGC algorithm can converge faster by, for example, setting the gain value to the locked value in the previous packed whenever ED is positive and then enters the sleep and tuning mode. The rationale behind this approach utilizes the slow time-variant nature of the received signal power between contiguous packets. The simulation results justify fast convergence of this approach.

In the sequel, a real example of the preferred embodiment employed in the IEEE 802.11b based-band receiver is further explained in the following paragraph.

Embodiment for IEEE 802.11b

According to the specifications in IEEE 802.11b, a range between the minimum input level and the maximum input level is, for example, 66 dB. In a practical design for IEEE 802.11b, the value is set to 86 dB with a safe margin of 20 dB.

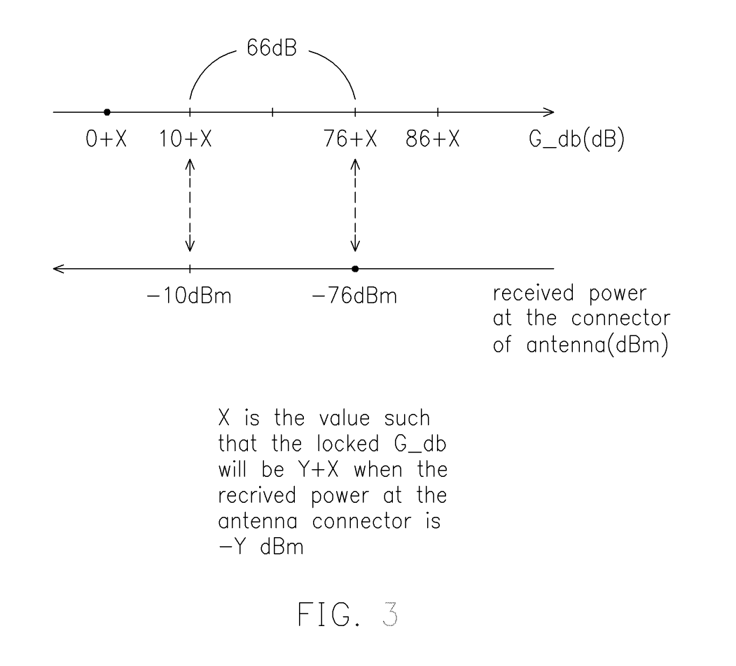

Referring to Fig.3, which is a preferred embodiment of the AGC algorithm employed in a digital processing system meeting the requirements of the specifications of IEEE 802.11b. In the design, it is assumed that a maximum noise power at a connector of an antenna is smaller than -86dBm. It is a reasonable assumption because the required signal-to-noise ratio (SNR) to reach 10 bit error probability for binary phase-shift keying (BPSK) modulation is around 10 dB in the additive white Gaussian noise (AWGN) channel and the minimum input level of signal power is -76 dBm.

A table is used for the measured envelope of the received signal to loop up a desired gain value. The span of the table depends on the number of bits of the employed ADC, because the signal energy is measured after ADC block. The larger the span of the table is, the faster convergence of the AGC algorithm can achieve. However, the maximum span of the table is limited by the accuracy of the table, which may reduce the speed of AGC convergence in turn. The energy of signal is measure for 1 μs.

$$Measure energy = {\sum }_{n = 0}^{21} \vert γ ( n ) \vert , \qquad ( 1 )$$

Where the number of samples within a microsecond is 22; γ(n) is the received sample from ADC; and |•| is the magnitude of γ(n) which is further approximated by

|γ(n)|=max{Re[γ(n)], Im[γ(n)]}+0.5min{Re[γ(n)], Im[γ(n)]}, (2)

where Re[γ(n)] and Im[γ(n)] are the real and imaginary parts of γ(n), respectively.

The desired energy (DE) can be obtained by simulations. In a preferred embodiment, the value is set to 363. In addition, the thresholds for ED are designed to be AgcThrEdLo=80 dB and AgcThrEdHi=85 dB. The AgcThrEdLo is the first predetermined threshold TH₁ and the AgcThrEdHi is the second predetermined threshold TH₂, as shown in Fig.2, for example.

In the practical simulations conducted, when the overall loop delay of AGC is within 3μs, the maximum time for convergence is 21μs with 0.94 confidence; when the loop delay is within 1 μs, the maximum time for convergence is 11 μs with 0.96 confidence. Therefore, we can have a programmable AGC mechanism by simply modifying the lookup table and the register AGCMICROTIME in the ASIC design.

A fast convergent AGC algorithm which is suitable for the digital processing was introduced in the present invention. The algorithm combats the difficulty of saturation effect due to ADC and speeds the time to convergence by adopting the two-step stages. Simulations have verified the effectiveness and advantages of the proposed algorithm of the present invention comparing to the conventional adaptive algorithm.

In addition, the time for convergence by utilizing the locked gain in the previous packet as long as the variation of the received power between contiguous packets is slow. In fact, the algorithm of the preferred embodiments of the invention is suitable to an ASIC design where the programmable feature inherited in the algorithm riches its capability and performance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

Claims

1. An automatic gain control (AGC) algorithm which is suitable for a digital processing system, the AGC algorithm comprising:
an adaptive stage for determining if strength of a first received signal is within a first range and is larger than a second threshold value, if no, measuring strength of sequentially received signals by adaptively adjusting the gain of the AGC algorithm until the strength of one of the sequentially received signals is within the first range and is larger than the second threshold value; and
a sleeping and tuning stage, wherein the AGC algorithm stops tuning the gain for a first period, and then measuring strength for sequentially received signals by iteratively adjusting the gain of the AGC algorithm until the strength of the other one of the sequentially received signals is within a second range and when the energy is within the second range, setting the gain according to the strength and locking the gain for remaining sequentially received signals.

2. The AGC algorithm of claim 1, wherein the adaptive stage is initialized when the strength of one of the sequentially received signals is larger than a first threshold value.

3. The AGC algorithm of claim 2, wherein the first threshold value is smaller than the second threshold value.

4. The AGC algorithm of claim 1, wherein the gain of the AGC algorithm is adaptively adjusted in accordance with the strength of the sequentially received signals.

5. The AGC algorithm of claim 4, wherein the strength of the sequentially received signal is the average envelope thereof.

6. The AGC algorithm of claim 4, wherein the strength of the sequentially received signals is the power thereof.

7. The AGC algorithm of claim 1, wherein the gain of the AGC algorithm is adaptively adjusted by looking up a table.

8. The AGC algorithm of claim 7, wherein the table includes step sizes for adaptively adjusting the gain of the AGC algorithm, the step sizes are modified according to a loop delay occurred in the digital processing system.

9. The AGC algorithm of claim 8, wherein the step size of the table is inversely proportion to the value of the loop delay occurred in the digital processing system.

10. The AGC algorithm of claim 7, wherein the gain of the AGC algorithm is adaptively adjusted by looking up the table in accordance with the strength of the sequentially received signal.

11. The AGC algorithm of claim 1, wherein the gain of the AGC algorithm is adaptively adjusted in a range between a maximum value and a minimal value.

12. A method for automatically controlling a gain of a digital processing system, the digital processing system sequentially receiving a plurality of analog signals, the method comprising:
calculating strength of one of the analog signals and determining if the strength is within a first range and is larger than a second threshold value, if no, sequentially calculating strengths of first following received analog signals by adaptively adjusting the gain until one of the strengths of the first following received analog signals is within the first range and than the second threshold value; and
stop tuning the gain for a first period;
sequentially calculating strengths of second following received analog signals after the first period and determining if the strength is within a second range, if no, by iteratively adjusting the gain of the AGC algorithm until one of the strengths of the second following received analog signals is within the second range, and then setting the gain according to the strength and locking the gain for remaining sequentially received signals.

13. The method of claim 12, wherein the adaptive stage is initialized when the strength of one of the sequentially received analog signals is larger than a first threshold value.

14. The method of claim 12, wherein the first threshold value is smaller than the second threshold value.

15. The method of claim 12, wherein the gain of the AGC algorithm is adaptively adjusted in accordance with the strength of the sequentially received signals.

16. The method of claim 15, wherein the strength of the sequentially received signal is the average envelope thereof.

17. The method of claim 15, wherein the strength of the sequentially received signals is the power thereof.

18. The method of claim 12, wherein, the gain of the AGC algorithm is adaptively adjusted by looking up a table.

19. The method of claim 18, wherein the table includes step sizes for adaptively adjusting the gain of the AGC algorithm, the step sizes are modified according to a loop delay occurred in the digital processing system.

20. The method of claim 19, wherein the step size of the table is inversely proportion to the value of the loop delay occurred in the digital processing system.

21. The method of claim 12, wherein the gain of the AGC algorithm is adaptively adjusted by the strength of the first received signal.

22. The method of claim 12, wherein the gain of the AGC algorithm is adaptively adjusted in a range between a maximum value and a minimal value.

23. An automatic gain control (AGC) algorithm which is suitable for a digital processing system which sequentially receives a plurality of analog signals, the AGC algorithm comprising:
sequentially measuring strength for each of the sequentially received analog signals by adaptively adjusting the gain of the AGC algorithm until the strength of one of the sequentially received analog signals is within a first range and is larger than a second threshold value; and
stop tuning the gain of the AGC algorithm for a first period, and then measuring strength for the sequentially received analog signals by iteratively adjusting the gain of the AGC algorithm until the strength of the other one of the sequentially received analog signals is within a second range and when the strength is within the second range, setting the gain according to the strength and locking the gain for remaining sequentially received analog signals.

24. The AGC algorithm of claim 23, wherein the digital processing system uses an indicator to indicate presence of the analog signals, wherein the indicator is set to be positive if the strength of the receiving signals received by the digital processing system is larger than the second threshold value.

25. The AGC algorithm of claim 24, wherein the indicator is set to be negative if the strength of the receiving signals received by the digital processing system is smaller than a first threshold value.

26. The AGC algorithm of claim 25, wherein the first threshold value is larger than the second threshold value.

27. The AGC algorithm of claim 23, wherein the gain of the AGC algorithm is adaptively adjusted by looking up a table.

28. The AGC algorithm of claim 27, wherein step sizes of the table is inversely proportion to the value of the loop delay occurred in the digital processing system.

29. The AGC algorithm of claim 23, wherein the gain of the AGC algorithm is adaptively adjusted in accordance with the strength of the sequentially received signals.

30. The AGC algorithm of claim 29, wherein the strength of the sequentially received signal is the average envelope thereof.

31. The AGC algorithm of claim 29, wherein the strength of the sequentially received signals is the power thereof.

32. The AGC algorithm of claim 23, wherein the gain of the AGC algorithm is adaptively adjusted in a range between a maximum value and a minimal value.

33. The AGC algorithm of claim 23, wherein the first period of stopping tuning the gain depends on a loop delay occurred in the digital processing system.

34. An automatic gain control (AGC) algorithm which is suitable for a digital processing system which sequentially receives a plurality of analog signals, the AGC algorithm comprising:
adaptively adjusting the gain of the AGC algorithm until strength of one of the sequentially received analog signals is within a first range and is larger than a second threshold value;
stops tuning the gain of the AGC algorithm for a first period, and then iteratively adjusting the gain of the AGC algorithm until the strength of the other one of the sequentially received analog signals is within a second range; and
setting the gain according to the energy and locking the gain for remaining sequentially received analog signals.

35. The AGC algorithm of claim 34, wherein the second range is much closer to a desired energy than the first range.
